(19) United States
(12) Patent Application Publication
(10) Pub. No.: US 2017/0136797 A1
(43) Pub. Date: May 18, 2017

(54) THERMAL TRANSFER IMAGE-RECEIVING SHEET

(71) Applicant: Dai Nippon Printing Co., Ltd., Tokyo (JP)

(72) Inventors: Ryota HATAKEYAMA, Tokyo (JP); Yoshinori KAMIKUBO, Tokyo (JP); Makoto HASHIBA, Tokyo (JP)

(73) Assignee: Dai Nippon Printing Co., Ltd., Tokyo (JP)

(21) Appl. No.: 15/127,582

(22) PCT Filed: Mar. 31, 2015
(86) PCT No.: PCT/JP2015/060107

§ 371 Date: Sep. 20, 2016

(30) Foreign Application Priority Data
Mar. 31, 2014 (JP) 2014-074552

(51) Int. Cl. B41M 5/41; B41M 5/52; B41M 5/44

(52) U.S. Cl. CPC B41M 5/41; B41M 5/44; B41M 5/5254; B41M 5/529; B41M 2205/02; B41M 2205/32; B41M 2205/34; B41M 2205/36; B41M 2205/38

(57) ABSTRACT

A thermal transfer image-receiving sheet which does not cause printing failure while being provided with tear-off lines. The sheet includes a dye-receiving layer on one side of a backing sheet, a tear-off line provided crossing the sheet along a width direction of the sheet and roller contact areas configured to contact a transport roller of a printer provided on opposite sides in the width direction. In each of the roller contact areas on the opposite sides, the tear-off line is not parallel to the width direction of the thermal transfer image-receiving sheet in an area occupying half or more of the roller contact area in the width direction, and when that segment of the tear-off line which is not parallel to the width direction of the thermal transfer image-receiving sheet has one or more bends in the roller contact area, all the bends are bent at obtuse angles.

### TECHNICAL FIELD

The present invention relates to a thermal transfer image-receiving sheet.

### BACKGROUND ART

It is widespread practice to form a thermal transfer image on a target object using a sublimation transfer method, which can easily form a high-quality image provided with excellent transparency as well as high reproducibility and tonality of neutral tints and equivalent to conventional full-color photographic images. Examples of printed matter in which a thermal transfer image is formed on a target object include digital photographs as well as ID cards used in many fields including the fields of identification cards, driver's licenses, member's cards, and the like.

In forming a thermal transfer image by the sublimation transfer method, a thermal transfer sheet, a target object, and a thermal transfer image-receiving sheet are used, where the thermal transfer sheet is produced by forming a dye layer on one side of a backing material and the thermal transfer image-receiving sheet is produced by forming a receiving layer on one side of another backing material. Then, the receiving layer of the thermal transfer image-receiving sheet and the dye layer of the thermal transfer sheet are laid on top of each other and heat is applied from a back side of the thermal transfer sheet by a thermal head, causing dye to migrate from the dye layer onto the receiving layer and thereby producing a printed matter with a thermal transfer image formed on the receiving layer. Being able to control an amount of dye migration by an amount of energy applied to the thermal transfer sheet and thereby provided with gray-scale capability, the above-mentioned sublimation transfer method can form high-quality printed matter characterized by very clear images and excellent transparency, halftone color reproducibility, and tonality and comparable to full-color photographs.

A printer employing the sublimation transfer method has a pair of transport rollers, such as a pinch roller and capstan roller, downstream of the thermal transfer image-receiving sheet in a transport direction, includes a mechanism adapted to rotate the thermal transfer image-receiving sheet by pinching the sheet between the pinch roller and capstan roller, and transports the thermal transfer image-receiving sheet to an image forming position through the rotation. Usually, a surface of the capstan roller is provided with a large number of spikes, which are fine protrusions. The spikes are configured to bite into a rear surface of a label-type thermal transfer image-receiving sheet by being pressed by the pinch roller and thereby prevents displacement of the thermal transfer image-receiving sheet.

Incidentally, some thermal transfer image-receiving sheets used for the printer employing the sublimation transfer method are provided with tear-off lines beforehand to cut the sheets into a predetermined size such as a photograph size or business card size after printing (see, for example, Patent Literature 1).

### CITATION LIST

### Patent Literature

Patent Literature 1: Japanese Patent Laid-Open No. 9-323484

### SUMMARY OF INVENTION

### Technical Problem

FIG. 6 is a schematic diagram showing a positional relationship between a capstan roller of a printer and a thermal transfer image-receiving sheet.

As illustrated in FIG. 6, when a thermal transfer image-receiving sheet 300 provided with a tear-off line 301 is used on the printer of the sublimation transfer type, if the tear-off line 301 in the thermal transfer image-receiving sheet 300 is formed rectilinearly parallel to a width direction of the sheet there can be a moment when the tear-off line 301 comes into contact simultaneously, i.e., with the same timing, with the spikes provided on the surface of the capstan roller 302. More specifically, during transport, the thermal transfer image-receiving sheet 300 and capstan roller 302 are always placed in contact with each other along a line L perpendicular to a transport direction (where the line L is an imaginary line), and there can be a moment when the imaginary line L coincides exactly with the tear-off line 301 as illustrated.

Here, the moment when the tear-off line 301 of the thermal transfer image-receiving sheet 300 overlaps the line L along which the thermal transfer image-receiving sheet 300 and the capstan roller 302 come into contact with each other, the spikes provided on the surface of the capstan roller 302 can bite into the tear-off line 301 momentarily, and it has become clear as a result of studies conducted by the inventors that transport speed of the thermal transfer image-receiving sheet 300 changes only at this moment, causing various printing failures.

The present invention has been made as a result of these studies and a main object of the present invention is to provide a thermal transfer image-receiving sheet which does not cause printing failure while being provided with tear-off lines.

### Solution to Problem

To solve the above problem, the present invention provides a thermal transfer image-receiving sheet provided with a dye-receiving layer on one side of a backing sheet, wherein: the thermal transfer image-receiving sheet has a tear-off line crossing the thermal transfer image-receiving sheet along a width direction of the thermal transfer image-receiving sheet and has roller contact areas configured to contact a transport roller of a printer on opposite sides in the width direction; in each of the roller contact areas on the opposite sides, the tear-off line is not parallel to the width direction of the thermal transfer image-receiving sheet in an area occupying half or more of the roller contact area in the width direction; and when that segment of the tear-off line which is not parallel to the width direction of the thermal transfer image-receiving sheet has one or more bends in the roller contact area, all the bends are bent at obtuse angles.

In the above invention, the entire tear-off line crossing the thermal transfer image-receiving sheet along the width direction may have a curved shape.

### Advantageous Effects of Invention

The thermal transfer image-receiving sheet according to the present invention is not subject to speed variation caused by the tear-off line and thus can prevent printing failure. Also, the thermal transfer image-receiving sheet can be cut off neatly along the tear-off line without any inconvenience.

### BRIEF DESCRIPTION OF DRAWINGS

FIG. 1 is a front view of a thermal transfer image-receiving sheet according to an embodiment of the present invention.

FIG. 2 is a front view of a thermal transfer image-receiving sheet according to another embodiment of the present invention.

FIGS. 3(a) and 3(b) are front views of part (neighborhood of a left roller contact area) of a thermal transfer image-receiving sheet according to another embodiment of the present invention.

FIG. 4 is a front view of part (neighborhood of a left roller contact area) of a thermal transfer image-receiving sheet according to another embodiment of the present invention.

FIG. 5 is a front view of a thermal transfer image-receiving sheet according to another embodiment of the present invention.

FIG. 6 is a schematic diagram showing a positional relationship between a capstan roller of a printer and a thermal transfer image-receiving sheet.

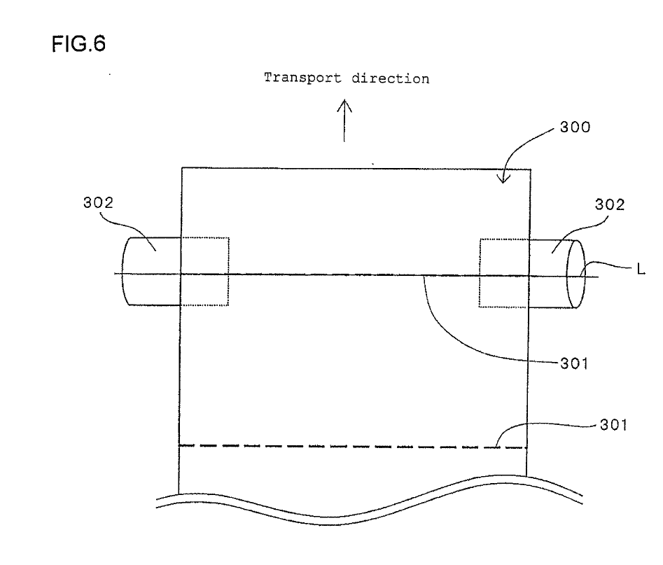

FIGS. 7(a) and 7(b) are reference diagrams for comparison with the thermal transfer image-receiving sheet according to the embodiment of the present invention shown in FIG. 4.

### DESCRIPTION OF EMBODIMENTS

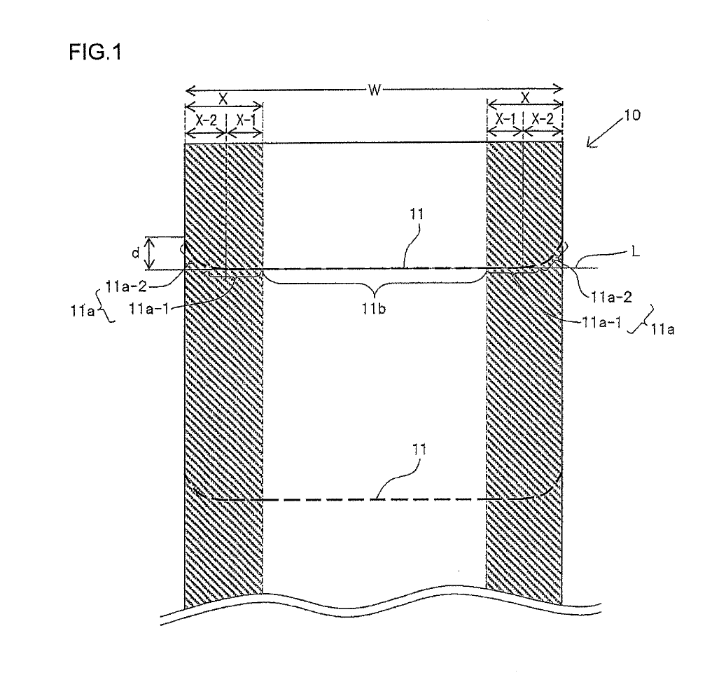

FIG. 1 is a front view of a thermal transfer image-receiving sheet according to an embodiment of the present invention.

As shown in FIG. 1, the thermal transfer image-receiving sheet 10 according to the present embodiment has a tear-off line 11 crossing the sheet along a width direction of the sheet (crosswise direction in FIG. 1) and has roller contact areas X configured to contact a transport roller of a printer on opposite sides (right and left in FIG. 1) in the width direction. In each of the roller contact areas X on the opposite sides, the tear-off line 11a is not parallel to the width direction of the thermal transfer image-receiving sheet in an area X-2 occupying half or more of the roller contact area X in the width direction and when a tear-off line 11a-2 which is not parallel to the width direction of the thermal transfer image-receiving sheet 10 has one or more bends in the roller contact area X, all the bends are bent at obtuse angles.

Note that the thermal transfer image-receiving sheet 10 according to the present embodiment shown in FIG. 1 does not need to satisfy the condition that “all the plural bends are bent at obtuse angles” because the tear-off line 11a-2 which is not parallel to the width direction of the thermal transfer image-receiving sheet 10 does not have a bend in the contact area X.

Also, although an imaginary straight line L parallel to the width direction of the thermal transfer image-receiving sheet 10 is shown in FIG. 1 for convenience of explanation, the straight line L is strictly an imaginary line, and is not a component of the thermal transfer image-receiving sheet 10 according to the present embodiment.

According to the present embodiment, on the thermal transfer image-receiving sheet 10, since the tear-off line 11a in the roller contact areas X coming into contact with the transport roller of the printer is configured such that a portion not parallel to the width direction of the thermal transfer image-receiving sheet is formed in the area X-2 occupying half or more of the roller contact area X in the width direction, the entire tear-off line 11 can be made non-rectilinear, making it possible to prevent the entire tear-off line 11 of the thermal transfer image-receiving sheet 10 from coming into contact with spikes on a transport roller, such as a capstan roller, of the printer of the sublimation transfer type with the same timing, and thereby prevent transport speed of the thermal transfer image-receiving sheet 10 from being changed.

Also, since the tear-off line 11a-2 which is not parallel to the width direction of the thermal transfer image-receiving sheet 10 does not have a bend in the contact area X, the thermal transfer image-receiving sheet can be cut off neatly along the tear-off line 11 without any inconvenience.

Here, in the present embodiment, the tear-off line 11 needs to be made non-parallel to the width direction of the thermal transfer image-receiving sheet only in the roller contact area X in which the tear-off line 11 comes into contact with the transport roller of the printer, and thus a tear-off line 11b which is located in an area other than the roller contact areas X may be parallel to the width direction of the thermal transfer image-receiving sheet as shown in FIG. 1. This is because the segment, which does not come into contact with the transport roller, does not cause speed variation. As shown in FIG. 1, it is preferable to configure the tear-off line 11b which is located in the area other than the roller contact areas X to be rectilinear because then, shape of a final product can be made close to a rectangular shape.

Also, there is no need to make the tear-off line 11 non-parallel to the width direction of the thermal transfer image-receiving sheet in the entire roller contact area X in which the tear-off line 11 comes into contact with the transport roller of the printer, and it is sufficient as described above that the tear-off line 11a-2 is not parallel to the width direction of the thermal transfer image-receiving sheet in the area X-2 occupying half or more of the roller contact area X in the width direction, and thus in an area X-1 occupying less than half the roller contact area X in the width direction, a tear-off line 11a-1 may be parallel to the width direction of the thermal transfer image-receiving sheet. This is because when the area X-2 in which the tear-off line 11a-2 not parallel to the width direction of the thermal transfer image-receiving sheet is less than half the roller contact area X in the width direction, it may become impossible to achieve the above-described operation and effect of preventing the entire tear-off line 11 of the thermal transfer image-receiving sheet from coming into contact with the spikes on a capstan roller with the same timing and thereby preventing the transport speed of the thermal transfer image-receiving sheet 10 from being changed.

Note that although this is not directly related to the thermal transfer image-receiving sheet 10 according to the present embodiment, preferably roller width of the transport roller of the printer on which the thermal transfer image-receiving sheet 10 is used is between 10 mm and 30 mm (both inclusive). Also, when transport rollers are provided separately on right and left, preferably the transport rollers are not placed in contact with each other.

Here, there is no particular limit to, so to say, an “amount of displacement” meaning the extent to which the tear-off line 11a-2 not parallel to the width direction of the thermal transfer image-receiving sheet is displaced from the tear-off line 11a-1 parallel to the width direction of the thermal transfer image-receiving sheet, i.e., the extent to which the tear-off line 11a-2 is displaced from the imaginary straight line L, and it is sufficient if the tear-off line 11a-2 is displaced to such an extent that the entire tear-off line does not come into contact with the transport roller with the same timing. Specifically, for example, as shown in FIG. 1, preferably a distance d between the imaginary straight line L and an end of the tear-off line 11 is 1 mm or more at each end of the thermal transfer image-receiving sheet 10 and more preferably from about 1.5 to 5.0 mm. This is because if the distance d is smaller than 1 mm, the displacement is insufficient and the entire tear-off line 11a might come into contact with the transport roller with the same timing, but on the other hand, if the distance is larger than 5.0 mm, the shape of the final printed matter might be affected greatly and perforations might become hard to break.

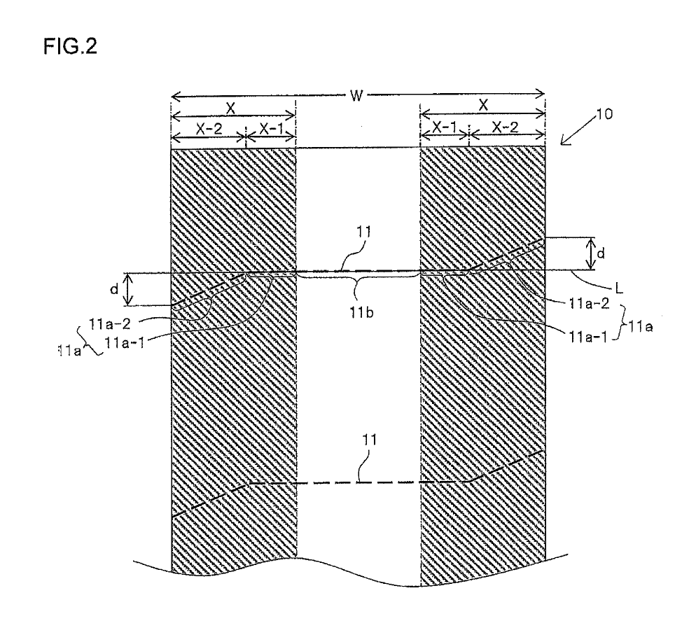

Note that as long as the distance d between the straight line L and the end of the tear-off line 11 at the end of the thermal transfer image-receiving sheet 10 is in the preferable range, the shape of the tear-off line does not make any difference. This is also true both when the tear-off line 11a has a curved shape as shown in FIG. 1 and when the tear-off line 11a has a rectilinear shape as shown in FIG. 2 described later.

When the tear-off line 11a has a curved shape, preferably a radius of curvature R thereof is between 50 mm and 500 mm (both inclusive) and particularly preferably between 100 mm and 300 mm (both inclusive).

Also, whereas in the embodiment shown in FIG. 1, the tear-off line 11 is curved toward the transport direction, i.e., upward in FIG. 1, rather than being parallel to the width direction of the thermal transfer image-receiving sheet, this is not restrictive, and the tear-off line 11 may be curved in a direction opposite the transport direction, i.e., downward in FIG. 1 although not illustrated.

FIG. 2 is a front view of a thermal transfer image-receiving sheet according to another embodiment of the present invention. Note that the same components as those in FIG. 1 are denoted by the same reference numerals as the corresponding components in FIG. 1.

In the thermal transfer image-receiving sheet 10 shown in FIG. 2, the tear-off lines 11a-2 which are not parallel to the width direction of the thermal transfer image-receiving sheet are rectilinear and are displaced in directions opposite each other at opposite ends of the thermal transfer image-receiving sheet 10. This form is also an embodiment of the present invention.

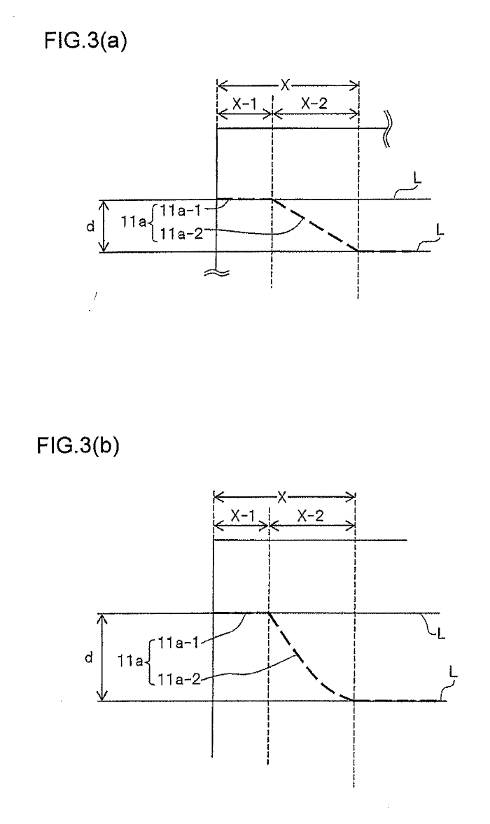

FIGS. 3(a) and 3(b) are front views of part (neighborhood of a left roller contact area) of a thermal transfer image-receiving sheet according to another embodiment of the present invention. Note that the same components as those in FIG. 1 are denoted by the same reference numerals as the corresponding components in FIG. 1.

As shown in FIG. 3(a), in the roller contact area X, the tear-off line 11a-2 which is not parallel to the width direction of the thermal transfer image-receiving sheet does not necessarily have to be located on a lateral side of thermal transfer image-receiving sheet 10, and may be located on a center side of the thermal transfer image-receiving sheet 10.

Also, as shown in FIG. 3(b), the tear-off line 11a-2 which is not parallel to the width direction of the thermal transfer image-receiving sheet in FIG. 3(a) may be a curve.

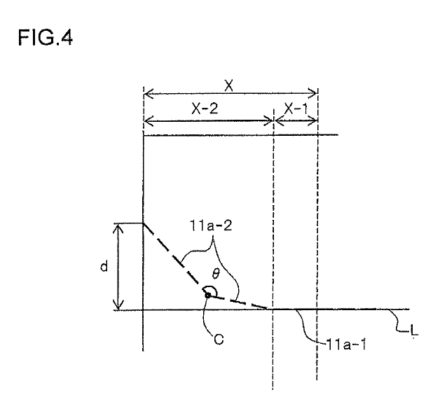

FIG. 4 is a front view of part (neighborhood of a left roller contact area) of a thermal transfer image-receiving sheet according to another embodiment of the present invention. Note that the same components as those in FIG. 1 are denoted by the same reference numerals as the corresponding components in FIG. 1.

The thermal transfer image-receiving sheet according to an embodiment of the present invention shown in FIG. 4 is characterized not only in that the tear-off line 11a in the roller contact area X is not parallel to the width direction of the thermal transfer image-receiving sheet in the area X-2 occupying half or more of the roller contact area X in the width direction, but also in that in the roller contact area X, the tear-off line 11a-2 which is not parallel to the width direction of the thermal transfer image-receiving sheet 10 has a bend C, which is bent at an obtuse angle θ. In other words, a direction in which the tear-off line before bending extends and a direction in which the tear-off line after bending extends are identical, that is, in FIG. 4, the tear-off line before bending extends upward of the thermal transfer image-receiving sheet 10 and the tear-off line after bending also extends upward. Note that the concept that “directions are identical” here means that the directions are both oriented upward or the directions are both oriented downward as well as that the directions are both oriented upward and parallel to the thermal transfer image-receiving sheet or the directions are both oriented downward and parallel to the thermal transfer image-receiving sheet.

In this way, the thermal transfer image-receiving sheet according to the present embodiment permits the tear-off line 11a-2 which is not parallel to the width direction of the thermal transfer image-receiving sheet 10 to have one or more bends C in the roller contact area X, but when the tear-off line 11a-2 has any bend C, the bend C has to be bent at an obtuse angle θ.

Note that although FIG. 4 shows a case in which one bend C is provided, this is not restrictive, and plural, i.e., two or more bends C can exist.

Also, although in FIG. 4, the bend is formed by two rectilinear tear-off lines, a bend may be formed by two curves or by a straight line and a curve. When a curve is included, the angle of the bend C is an angle made with a tangent to a curve near the bend.

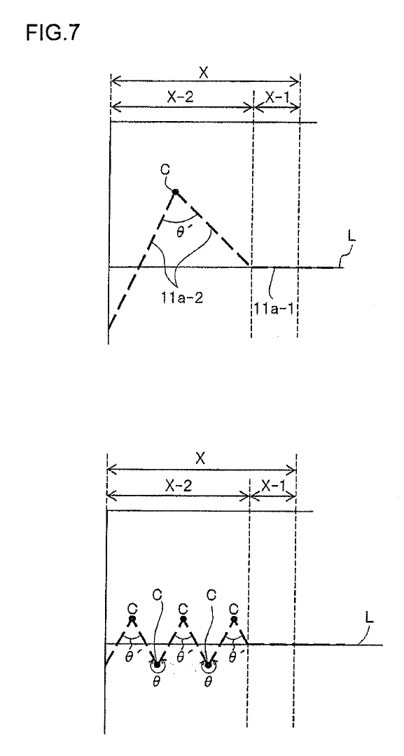

FIGS. 7(a) and 7(b) are reference diagrams for comparison with the thermal transfer image-receiving sheet according to the embodiment of the present invention shown in FIG. 4.

The thermal transfer image-receiving sheet shown in each of FIGS. 7(a) and 7(b) is similar to the thermal transfer image-receiving sheet according to the present embodiment shown in FIG. 4 in that the tear-off line 11a in the roller contact area X is not parallel to the width direction of the thermal transfer image-receiving sheet in the area X-2 occupying half or more of the roller contact area X in the width direction and that the tear-off line 11a-2 not overlapping the straight line L parallel to the width direction of the thermal transfer image-receiving sheet 10 has one (FIG. 7(a)) or more (FIG. 7(b)) bends C in the roller contact area X, but differs from the thermal transfer image-receiving sheet according to the present embodiment in that the bend C is bent at an acute angle θ′. In other words, the thermal transfer image-receiving sheet shown in each of FIGS. 7(a) and 7(b) differs from the thermal transfer image-receiving sheet according to the present embodiment in that a direction in which the tear-off line before bending extends and a direction in which the tear-off line after bending extends differ from each other, i.e., in that in FIG. 7(a), the tear-off line before bending extends upward of the thermal transfer image-receiving sheet while the tear-off line after bending extends downward at an acute angle.

In this way, when the bend θ′ is bent at an acute angle, it is troublesome to cut off the thermal transfer image-receiving sheet along the tear-off line and sometimes impossible to cut off the sheet neatly, but the thermal transfer image-receiving sheet according to the present embodiment can reduce the risk of such trouble.

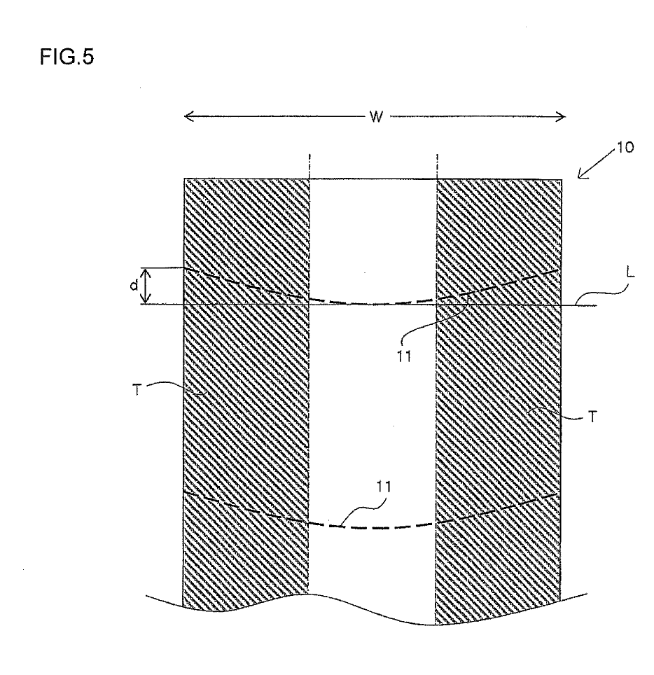

FIG. 5 is a front view of a thermal transfer image-receiving sheet according to another embodiment of the present invention. Note that the same components as those in FIG. 1 are denoted by the same reference numerals as the corresponding components in FIG. 1.

The thermal transfer image-receiving sheet 20 shown in FIG. 5 is characterized in that the entire tear-off line 11 crossing the sheet along the width direction W has a curved shape.

This form is also an embodiment of the present invention and can achieve the above-mentioned operation and effect.

Now, a basic configuration of the thermal transfer image-receiving sheet 10 according to the present embodiment will be described.

The basic configuration of the thermal transfer image-receiving sheet 10 according to the present embodiment is only that a dye-receiving layer is provided on one side of a backing sheet, but otherwise the thermal transfer image-receiving sheet 10 is not limited at all. Thus, the type, size, thickness, and the like of the backing material can be designed freely and component composition, size, thickness, and the like of the dye-receiving layer can also be designed freely. Furthermore, components other than the backing material and dye-receiving layer may be added. For example, a thermal transfer image-receiving sheet provided with a back layer or a label-type thermal transfer sheet provided with release liner may also be adopted.

A concrete layer configuration of the thermal transfer image-receiving sheet according to the present embodiment serving as a thermal transfer recording material will be described in detail below.

(Backing Sheet)

The backing sheet of the thermal transfer image-receiving sheet is not particularly limited, and materials available for use include, for example, condenser paper, glassine paper, parchment paper, synthetic paper (polyolefin, polystyrene, and the like), fine paper, art paper, coated paper, cast-coated paper, wall paper, lining paper, synthetic resin or emulsion impregnated paper, synthetic rubber latex impregnated paper, synthetic resin-filled paper, cardboard and the like, cellulose fiber paper, cellulose paper coated on both sides with polyethylene, i.e., resin-coated paper used as a backing material for photographic paper of silver salt photography; and various plastics films or sheets of polyester, polyacrylate, polycarbonate, polyurethane, polyimide, polyetherimide, cellulose derivatives, polyethylene, ethylene-vinyl acetate copolymer, polypropylene, polystyrene, acrylic, polyvinyl chloride, and polyvinylidene chloride. Also, a film (porous film) formed by adding a white pigment or filler to any of the above synthetic resins and having micro voids in a backing sheet is also available for use.

In relation to the porous film, as a method for producing the micro voids in the film a method can be adopted which creates the micro voids using a compound produced by kneading a resin serving as a base for the film with fine organic particles or fine inorganic particles (of either one type or plural types) non-compatible with the resin. When viewed microscopically, the resin serving as the base and the particles non-compatible with the resin serving as the base form a minute sea-island structure in the compound. The compound is processed into film and stretched to separate a sea-island interface or greatly deform regions making up islands and thereby produce micro voids such as described above.

Examples of methods for producing micro voids include a method which uses polypropylene as a principal material and adds polyester or acrylic resin having a melting point higher than polypropylene to the principal material. In this case, polyester or acrylic resin plays a role of a nucleating additive used to form the micro voids. Preferably content of polyester or acrylic resin is 2 to 10 parts by mass in 100 parts by mass of polypropylene. When the content is 2 parts by mass or above, micro voids can be generated sufficiently and printing sensitivity can be improved further. Also, when the content is 10 parts by mass or less, heat resistance of the porous film can be secured sufficiently.

Also, in creating a polypropylene resin-based porous film, in order to generate a larger number of fine micro voids, preferably polyisoprene is added further. This provides higher printing sensitivity. For example, a porous film having high printing sensitivity can be obtained if a compound is prepared by mixing acrylic resin or polyester, and polyisoprene in polypropylene serving as a principal material, processed into film, and then stretched.

Also, a laminate produced by any combination of the above-described materials can be used as a backing sheet. Examples of typical laminates include a laminate of cellulose fiber paper and synthetic paper, and a laminate of cellulose fiber paper and plastic film or sheet. Such laminated synthetic paper may be a two-layered body or to bring out a feel and texture of the backing material, the laminated synthetic paper may be a three-layered body produced by bonding synthetic paper, plastic film, or porous film to both sides of cellulose fiber paper (used as a core) or a laminate made up of more than three layers. Alternatively, the laminated synthetic paper may be a laminate produced by scattering hollow particles and thereby applying a resin layer to surfaces of coated paper, resin coated paper, plastic film, or the like to give heat-insulating properties.

A bonding method for the laminate may employ any of dry lamination, wet lamination, extrusion, and other techniques. The bonded backing material may have any desired thickness, and usually a thickness of around 10 to 300 μm is in common use. Also, if the backing sheet such as described above has poor adhesion to the layer formed on its surface, preferably any of various types of primer treatment and corona discharge treatment is applied to the surface.

(Dye-Receiving Layer)

The dye-receiving layer of the thermal transfer image-receiving sheet used in the present invention is intended to receive sublimation dye migrating from the thermal transfer sheet and maintain a formed image. Examples of resins used to form the dye-receiving layer include polycarbonate resin, polyester resin, polyamide resin, acrylic resin, cellulosic resin, polysulfone resin, polyvinyl chloride resin, polyvinyl acetate resin, vinyl chloride-vinyl acetate copolymer resin, polyvinyl acetal resin, polyvinyl butyral resin, polyurethane resin, polystyrene resin, polypropylene resin, polyethylene resin, ethylene-vinyl acetate copolymer resin, and epoxy resin. Note that the resin used to form the dye-receiving layer may be either so-called solvent-based resin or water-based resin.

The thermal transfer image-receiving sheet may contain a release agent in the dye-receiving layer to improve releasability from the thermal transfer sheet. Examples of the release agent include solid waxes such as polyethylene wax, amide wax, and Teflon (registered trademark) powder; fluorine-based and phosphate ester-based surfactants; various modified silicone oils such as silicone oil, reactive silicone oil, and curing silicone oil; and various silicone resins, of which silicone oil is preferable. As the silicone oil, silicone oil in a hardened state is preferable although silicone oil in a liquid state may also be used. Examples of the curing type silicone oil include a reaction-curing type, light-curing type, and catalyst-curing type, of which reaction-curing silicone oil and catalyst-curing silicone oil are particularly preferable.

Preferably the reactive silicone oil is amino-modified silicone oil and epoxy-modified silicone oil subjected to reaction curing. Examples of the amino-modified silicone oil include KF-393, KF-857, KF-858, X-22-3680, and X-22-3801C (made by Shin-Etsu Chemical Co., Ltd.) and examples of epoxy-modified silicone oil include KF-100T, KF-101, KF-60-164, and KF-103 (made by Shin-Etsu Chemical Co., Ltd.). Examples of catalyst-curing silicone oil include KS-705, FKS-770, and X-22-1212 (made by Shin-Etsu Chemical Co., Ltd.). Preferably an additive amount of the curing type silicone oil is 0.5 to 30 mass % of the resin making up the receiving layer.

In forming the dye-receiving layer, to improve whiteness of the dye-receiving layer and further improve definition of the transfer image, a pigment or filler such as titanium oxide, zinc oxide, kaolin, clay, calcium carbonate, or impalpable powder silica can be added. Also, a plasticizer such as a phthalate ester compound, sebacic acid ester compound, phosphate ester compound may be added.

The thickness of the dye-receiving layer is not particularly limited as long as a desired image density can be achieved, but an amount of coating of solid matter is usually g/m² to 20 g/m², and preferably 1 g/m² to 15 g/m². The receiving layer can be formed by commonly used coating means. For example, coating can be done using means such as gravure printing, screen printing, or reverse roll coating by the use of a photogravure and then dried to form the receiving layer.

(Intermediate Layer)

Any of conventionally known intermediate layer may be provided as required between the dye-receiving layer and backing sheet in addition to the primer layer to impart whiteness, cushioning properties, concealment properties, antistatic properties, anti-curl properties, and the like. Examples of binder resin available for use as the intermediate layer include polyurethane resin, polyester resin, polycarbonate resin, polyamide resin, acrylic resin, polystyrene resin, polysulfone resin, polyvinyl chloride resin, polyvinyl acetate resin, vinyl chloride-vinyl acetate copolymer resin, polyvinyl acetal resin, polyvinyl butyral resin, polyvinyl alcohol resin, epoxy resin, cellulosic resin, ethylene-vinyl acetate copolymer resin, polyethylene resin, and polypropylene resin, of which those having hydroxyl radicals may further use the resins subjected to isocyanate curing as binders.

Also, to impart whiteness and concealment properties, preferably a filler such as titanium oxide, zinc oxide, magnesium carbonate, calcium carbonate, or the like is added. Furthermore, a stilbene compound, benzoimidazole compound, benzooxazole compound, or the like may be added as a fluorescent whitening agent to enhance whiteness, a hindered amine compound, hindered phenolic compound, benzotriazole compound, a benzophenone-based compound, or the like may be added as a UV absorber or antioxidant to increase light stability of printed matter, or cationic acrylic resin, polyaniline resin, any of various conductive fillers, or the like may be added to impart antistatic properties. Preferably an amount of coating of the intermediate layer is around 0.5 to 30 g/m² in dry state.

(Back Layer)

Also, a back layer may be provided on an opposite side of the backing sheet from the dye-receiving layer to improve mechanical transportability, prevent curling, improve ease of writing, prevent electrostatic charges, and the like. The back layer may be made up of either only a single layer or a laminate of two or more layers differing in composition and the like.

The back layer can be formed, for example, of resin such as polyurethane resin, polyester resin, polybutadiene resin, poly(meta) acrylic acid ester resin, epoxy resin, polyamide resin, rosin-modified phenolic resin, terpene phenol resin, ethylene-vinyl acetate copolymer resin, polyolefin resin, cellulosic resin, gelatin, casein, or the like. Also, the back layer may have, for example, a water-soluble polymer added. Examples of the water-soluble polymer include cellulosic resin, starch, polysaccharides such as agar, casein, protein such as gelatin, polyvinyl alcohol, ethylene-vinyl acetate copolymer, polyvinyl acetate, poly vinyl chloride-vinyl acetate copolymer, vinyl acetate-(meta)acrylic copolymer, vinyl acetate-Veova copolymer, (meta)acrylic resin, styrene-(meta) acrylic copolymer, vinyl resin such as styrene resin, melamine resin, urea resin, polyamide resin such as benzoguanamine resin, polyester, and polyurethane. According to the present invention, the water-soluble polymer means a macromolecule which goes into a state of complete dissolution (particle size: 0.01 μm or less), colloidal dispersion (particle size: 0.01 to 0.1 μm), emulsion (particle size: 0.1 to 1 μm), or slurry (particle size: 1 μm or above) in an aqueous solvent.

In forming the back layer, if, for example, (1) an appropriate amount of an organic filler or inorganic filler is added in addition to any of the resins described above by way of example or (2) a resin with high smoothness such as polyolefin resin or cellulosic resin is used, a thermal transfer image-receiving sheet with improved transportability can be obtained. When a resin, such as polyvinyl alcohol or polyethylene glycol, having water retentivity is used as a major component, curling of the resulting thermal transfer image-receiving sheet can be prevented. Also, in forming the back layer, if the pigment, filler, or the like described above as an additive for the receiving layer by way of example is mixed in, ease of writing can be imparted to the resulting thermal transfer image-receiving sheet.

To attain an antistatic function, the back layer may contain conductive resin such as acrylic resin and/or any of various antistatic agents such as fatty acid ester, sulfuric ester, phosphate ester, and an ethylene oxide adduct.

The thickness of the back layer is not particularly limited, but is around 0.1 g/m² to 3.0 g/m² in terms of an amount of coating of solid matter. The back layer can be formed by commonly used coating means. For example, coating can be done using means such as gravure printing, screen printing, or reverse roll coating by the use of a photogravure and then dried to form the back layer.

(Adhesive Layer)

Also, when the backing sheet is a laminate, an adhesive layer is provided between each pair of layers, and an adhesive layer may also be provided between the backing sheet and the intermediate layer or back layer. The adhesive layer is made of an adhesive and, for example, urethane resin, polyolefin resin such as alpha olefin-maleic anhydride resin, polyester resin, acrylic resin, epoxy resin, urea resin, melamine resin, phenolic resin, vinyl acetate resin, cyanoacrylate resin, and the like are available for use as the adhesive. Above all, reactive acrylic resin, modified acrylic resin, and the like are used preferably.

Also, preferably the adhesive is cured using a curing agent because this improves adhesive power and heat resistance of the adhesive. An isocyanate compound is commonly used as a curing agent, but fatty amine, cyclic fatty amine, aromatic amine, acid anhydride, and the like are also available for use. The thickness of the adhesive layer is usually around 0.5 g/m² to 10 g/m² in terms of the amount of coating of solid matter. The adhesive layer can be formed by commonly used coating means. For example, coating can be done using means such as gravure printing, screen printing, or reverse roll coating by the use of a photogravure and then dried to form the adhesive layer. Also, EC sandwich lamination may be carried out using a polyolefin material or the like.

On the other hand, the tear-off line 11 provided in the thermal transfer image-receiving sheet is not particularly limited, and a conventionally known tear-off line can be adopted appropriately. For example, lengths of cut portions and uncut portions may be 0.25/0.20.

### EXAMPLES

Next, the present invention will be described more concretely using examples and comparative examples. In the following description, “parts” and “%” indicate mass standards unless otherwise specified.

(Creating a thermal transfer image-receiving sheet)

Coated paper (basis weight: 157 g/m²; thickness: 130 μm) was used as a backing sheet.

Also, porous polypropylene film (thickness: 23 μm; density: 0.6 g/m³) was prepared as porous film for use to form a porous layer and was coated as follows to form a primer layer and a dye-receiving layer: a coating liquid for a primer layer was applied using a gravure coater such that application quantity will be 2 g/m² after drying and the coating was dried at 110 degrees C. for one minute, then a coating liquid for a dye-receiving layer was applied from above using the gravure coater such that application quantity will be 4 g/m² after drying, and the coating was dried at 110 degrees C. for one minute. The coating liquids had the compositions described below.

Next, a coating liquid for an adhesive layer was applied to one side (front side) of the coated paper using the gravure coater and an adhesive layer was formed such that the application quantity will be 5 g/m² after drying. The coating liquid had the composition described below. Then, using a dry lamination process, pieces of the porous polypropylene film were laminated by bonding together the pieces on the side opposite the side on which the receiving layer was formed.

<Coating Liquid for Primer Layer>
50 parts of polyester resin (Polyester WR-905 made by Nippon Synthetic Chemical Industry Co., Ltd.)
20 parts of titanium oxide (TCA888 made by Tohkem Products Corporation)
1.2 parts of fluorescent whitening agent (Uvitex BAC made by Ciba Specialty Chemicals, Inc.).
Water/isopropyl alcohol=1/128.8 parts

<Composition of Coating Liquid for Dye-Receiving Layer>
60 parts of vinyl chloride-vinyl acetate copolymer (Solbin C (trade name) made by Nissin Chemical Industry Co., Ltd.)
1.2 parts of epoxy-modified silicone (X-22-3000T (trade name) made by Shin-Etsu Chemical Co., Ltd.)
0.6 parts of methyl ethyl-modified silicone (24-510 (trade name) made by Shin-Etsu Chemical Co., Ltd.)
Methyl ethyl ketone/toluene=1/15 parts

<Coating Liquid for Adhesive Layer>
30 parts of urethane resin (TAKELAC A-969V made by Mitsui Takeda Chemicals Inc.)
10 parts of isocyanate (TAKENATE A-5 made by Mitsui Takeda Chemicals Inc.)
60 parts of ethyl acetate

Mat-tone non-porous polypropylene film (thickness: 20 μm) was prepared as mat-tone non-porous film for use to form a non-porous layer. Next, a coating liquid for an adhesive layer was applied to the other side (back side) of the coated paper using the gravure coater and an adhesive layer was formed such that the application quantity will be 5 g/m² after drying. The coating liquid had the same composition as above. Then, using a dry lamination process, pieces of the mat-tone non-porous polypropylene film were laminated by bonding together the pieces.

Next, a back side primer layer and a back layer were formed as follows: a coating liquid for a back side primer layer was applied onto the mat-tone non-porous polypropylene film using the gravure coater such that application quantity will be 0.2 g/m² after drying and the coating was dried at 110 degrees C. for one minute, and then a coating liquid for a back layer was applied from above using the gravure coater such that application quantity will be 0.4 g/m² after drying and the coating was dried at 110 degrees C. for one minute. The coating liquids had the compositions described below. Consequently, a thermal transfer image-receiving sheet was obtained.

<Composition of Coating Liquid for Back Side Primer Layer>
100 parts of urethane resin (OPT Primer (trade name) made by Showa Ink Manufacturing Co., Ltd.)
5 parts of isocyanate-based curing agents (OPT Koka-zai (trade name) made by Showa Ink Manufacturing Co., Ltd.)

<Composition of Coating Liquid for Back Layer>
10 parts of vinyl butyral resin (Denka Butyral 3000-1 (trade name) made by Denka Company Limited)
0.75 parts of silica dioxide (Sylysia (trade name) made by Fuji Silysia Chemical Ltd.)
0.117 parts of titanium chelate (AT Kireto-zai (trade name) made by Denka Polymer Kabushiki Kaisha)

(Forming a Tear-Off Line)

In the thermal transfer image-receiving sheets obtained as described above, perforations used to cut off the sheets by folding the sheets were formed in the shapes shown in the table below both in examples and comparative examples: the perforations were formed by alternating cut portions 0.23 mm long and uncut portions 0.28 mm long using a perforation blade. Immediately afterward, within the same process line as the perforation process, the portions in which perforations were formed were pressurized along the perforations from the back side of the thermal transfer image-receiving sheets by a press roll (pressurizing width: 4.5 mm) and an impression cylinder (under a pressurizing condition of 3 kgf/4.5 mm width; the material of the contact surface of both press roll and impression cylinder was stainless steel). Then the burrs produced around the perforations were smoothed and consequently the thermal transfer image-receiving sheets for the examples and comparative examples were obtained.

<Evaluation Method>

(Evaluation of Prints)

Solid black was printed on the duplex thermal transfer image-receiving sheets of the examples and comparative examples using CP-760 Printer (made by Canon Inc.) and thermal transfer sheets for CP-760 Printer and the prints were evaluated according to the following criteria.

◯: No print blemish.

Δ: Print blemishes caused by perforations were observed, but there was no problem in quality.

x: Print blemishes caused by perforations were observed, and there was a problem in quality.

(Evaluation of Tearability of Perforated Portions)

The printed matter printed to evaluate prints were cut off along the perforation by hand and evaluated according to the following criteria.

◯: The sheet was easy to cut off.

x: The sheet was not easy to cut off.

The shapes of the tear-off lines in the examples and comparative examples as well as the results of the two evaluations are summarized in Table 1 below. Note that R in the table indicates the radius of curvature (unit: mm).

TABLE 1

| | | | | | | | | Evaluation results | |
|---|---|---|---|---|---|---|---|---|---|
| | | | | | | | | | Tearability of |
| | Shape of tear-off line in area X | | | | | | | | perforated |
| | X | X-1 | | 11a-1 | X-2 | | 11a-2 | Print | portion |
| Example 1 | 25 mm | 25 | mm | Curve with R400 | 0 | mm | — | ∘ | ∘ |
| Example 2 | 25 mm | 12 | mm | Straight line | 13 | mm | Curve with R200 | ∘ | ∘ |
| | | | | continuing from 11b | | | | | |
| Example 3 | 25 mm | 12 | mm | Straight line | 13 | mm | Curve with R100 | ∘ | ∘ |
| | | | | continuing from 11b | | | | | |
| Example 4 | 25 mm | 12 | mm | Straight line | 13 | mm | Straight line with | ∘ | ∘ |
| | | | | continuing from 11b | | | d = 3 mm | | |
| Example 5 | 25 mm | 12 | mm | Straight line | 13 | mm | Straight line with | ∘ | ∘ |
| | | | | continuing from 11b | | | d = 1.5 mm | | |
| Example 6 | 10 mm | 10 | mm | Curve with R400 | 0 | mm | — | ∘ | ∘ |
| Example 7 | 10 mm | 5 | mm | Straight line | 5 | mm | Curve with R100 | ∘ | ∘ |
| | | | | continuing from 11b | | | | | |
| Example 8 | 10 mm | 5 | mm | Straight line | 5 | mm | Straight line with | ∘ | ∘ |
| | | | | continuing from 11b | | | d = 1.5 mm | | |
| Comparative | 25 mm | 25 | mm | Straight line | 0 | mm | — | x | ∘ |
| example 1 | | | | continuing from 11b | | | | | |
| Comparative | 25 mm | 12 | mm | Straight line | 13 | mm | Zigzag with two | ∘ | x |
| example 2 | | | | continuing from 11b | | | vertices, one of | | |
| | | | | | | | which is an acute | | |
| | | | | | | | angle (height | | |
| | | | | | | | difference between | | |
| | | | | | | | higher and lower | | |
| | | | | | | | vertices is 3 mm) | | |

As is also clear from Table 1, with the thermal transfer image-receiving sheet in any of the examples of the present invention, there is no print blemish caused by the tear-off lines and the tear-off lines have excellent tearability.

### REFERENCE SIGNS LIST

10 . . . Thermal transfer image-receiving sheet
11, 11a-1, 11a-2, 11b . . . Tear-off line
X . . . Roller contact area
C . . . Bend

1. A thermal transfer image-receiving sheet provided with a dye-receiving layer on one side of a backing sheet, wherein:
the thermal transfer image-receiving sheet has a tear-off line crossing the thermal transfer image-receiving sheet along a width direction of the thermal transfer image-receiving sheet and has roller contact areas configured to contact a transport roller of a printer on opposite sides in the width direction;
in each of the roller contact areas on the opposite sides, the tear-off line is not parallel to the width direction of the thermal transfer image-receiving sheet in an area occupying half or more of the roller contact area in the width direction;
in an area other than the each of the roller contact areas on the opposite sides, the tear-off line is parallel to the width direction of the thermal transfer image-receiving sheet; and
when that segment of the tear-off line which is not parallel to the width direction of the thermal transfer image-receiving sheet has one or more bends in the roller contact area, all the bends are bent at obtuse angles.

2. (canceled)
